(19) United States
(12) Patent Application Publication
(10) Pub. No.: US 2014/0108307 A1
(43) Pub. Date: Apr. 17, 2014

(54) METHODS AND SYSTEMS FOR PROVIDING PERSONALIZED AND CONTEXT-AWARE SUGGESTIONS

(71) Applicants: Sriraman Kandhadai RAGHUNATHAN, Bangalore (IN); Abhijeet Jaswal, Bangalore (IN)

(72) Inventors: Sriraman Kandhadai RAGHUNATHAN, Bangalore (IN); Abhijeet Jaswal, Bangalore (IN)

(73) Assignee: Wipro Limited

(21) Appl. No.: 13/747,509

(22) Filed: Jan. 23, 2013

(30) Foreign Application Priority Data
Oct. 12, 2012 (IN) 4271/CHE/2012

(51) Int. Cl. G06N 99/00

(52) U.S. Cl. CPC G06N 99/005
USPC 706/12

(57) ABSTRACT

Embodiments of the disclosure relate to methods and systems for providing personalized and context-aware suggestions to a user. The method includes providing a user profile. Further, the method includes establishing contextual information regarding the user. Thereafter, one or more suggestions are provided to the user based on the user profile and the contextual information. Subsequently, the user profile based on the user feedback in response to the suggestion is modified. The user profile may be modified using a machine learning algorithm executed on a processor in order to improve the quality of the personalized and context-aware suggestions. In certain embodiments, the personalized and context-aware suggestions can be provided while the user is in a vehicle or while the user is operating a vehicle.

### RELATED APPLICATIONS

This application claims priority to Indian Patent Application No. 4271/CHE/2012, filed Oct. 12, 2012, the contents of which are incorporated herein by reference.

### TECHNICAL FIELD

The present disclosure relates to autonomous, self-learning technologies and, more particularly, embodiments of the present disclosure relate to methods and systems for providing personalized and context-based suggestions to a user. Potential applications of the disclosed subject matter include, for example, providing personalized and context-based suggestions to the user via personal digital companions, such as navigation systems.

Many vehicles today include navigation systems that typically employ position data from the Global Positioning System (GPS) to determine a vehicle or user's location. As an example, commonly known navigation systems combine the ability to locate one's position, using maps stored on a hard drive or CD-ROM. In operation, a user inputs a destination name, and the system determines the route to the destination's location from the position of the vehicle that it has calculated. Finally, the determined route is displayed to the user through a display device. Often, such navigation systems can provide route instructions or directions, as well as identify various points of interest (POIs), such as hotels, hospitals, service stations, retail stores, restaurants, recreational areas, and landmarks.

With the advent of social networking, email applications, ubiquitous computing, and mobile technology, users—including drivers—like to stay in touch with friends, colleagues, or others. Drivers also prefer to have quick access to information. While driving, however, it is not possible for the user to connect with friends or to access the information quickly. For example, a driver may become hungry. If located on an unknown route, the driver faces difficulty in locating a nearby restaurant. Even if a restaurant is nearby, a difficulty remains in matching restaurant choices to the driver's preferences. Without access to information, a driver remains unaware of an opportunity to visit a preferred restaurant on his route. Many other scenarios can be imagined in which a driver misses an opportunity to take advantage of a sales opportunity, meet a friend, or avoid traffic.

While existing GPS systems can provide excellent information about the general characteristics of a route, existing technology does not allow for real-time updates, such as an accident that may have occurred on the planned route. Moreover, existing technology is likewise not able to tailor responses to changing preferences of a user. Some route information is available on GPS systems, such as locations along the route, but the system cannot take the users preferences into account in evaluating those locations, nor can the system take recent user behavior into consideration. Present technology lacks the ability not only to recognize that the driver prefers Indian cuisine, but also to remember that the driver recently dined in an Indian restaurant and, thus, might prefer her second choice: Italian.

Additionally, the existing systems can learn frequently driven routes, but those systems are not sufficiently adaptive to draw inferences from a users personal history or preferences when learning those routes. In other words, existing systems do not build customized driver profiles through self-awareness and self-learning. Thus, there is a need for improved systems and methods capable of better addressing the inconveniences faced by the user while driving.

### SUMMARY

One embodiment of the present disclosure relates to a method of providing personalized and context-aware suggestions to a user in a vehicle, the method comprising: providing a user profile; establishing contextual information relevant to the user, wherein the contextual information comprises information obtained from social communications of the user; providing a suggestion to the user, while the user s in a vehicle, based on the user profile and the contextual information; and modifying, using a machine learning algorithm executed on a processor, the user profile based on user feedback received in response to the suggestion.

Another embodiment of the present disclosure relates to a system for providing personalized and context-aware suggestions to a user, the system comprising: one or more hardware processors; and a memory storing instructions to configure the one or more hardware processors, wherein the one of more hardware processors are configured by the instructions to: provide a user profile; establish contextual information relevant to the user, wherein the contextual information comprises information obtained from social communications of the user; provide a suggestion to the user, while the user is in a vehicle, based on the user profile and the contextual information; and modify the user profile based on user feedback received in response to the suggestion using a machine learning algorithm being executed on the one or more hardware processors.

Another embodiment of the present disclosure relates to a non-transitory computer-readable medium storing instructions for providing personalized and context-aware suggestions to a user in a vehicle, wherein execution of the instructions by one or more processors causes the one or more processors to: provide a user profile; establish contextual information relevant to the user, wherein the contextual information comprises information obtained from social communications of the user; provide a suggestion to the user. while the user is in a vehicle, based on the user profile and the contextual information; and modify the user profile based on user feedback received in response to the suggestion using a machine learning algorithm.

Additional objects and advantages of the present disclosure will be set forth in part in the description which follows, and in part will be obvious from the description, or may be learned by practice of embodiments of the present disclosure. These objects and advantages will be realized and attained by means of the elements and combinations particularly pointed out in the appended claims.

It is to be understood that both the foregoing general description and the following detailed description are merely exemplary and explanatory and are not restrictive of the claims

### BRIEF DESCRIPTION OF THE DRAWINGS

FIG. 1 illustrates a system in accordance with the present disclosure

FIG. 2 depicts various components of a system in accordance with the present disclosure.

FIG. 3 is a flowchart illustrating a method for providing personalized and context-aware suggestions to a user.

FIG. 4 depicts an exemplary embodiment of the present disclosure.

FIG. 5 illustrates a scenario wherein a user may obtain a system in accordance with the present disclosure by downloading software instructions onto a mobile device.

### DETAILED DESCRIPTION

For simplicity and clarity, methods and systems in accordance with the present disclosure will be explained in the context of vehicle navigation. Accordingly, a user of the vehicle may also be interchangeably referred to as a driver. But a person skilled in the art will understand that the disclosure is not limited to the vehicle navigation, but can also be implemented in other applicable areas. For example, methods and systems in accordance with the present disclosure may be adapted for use by a pedestrian user, a user riding a bicycle, or a user employing public transportation (e.g. bus, train, subway, etc.

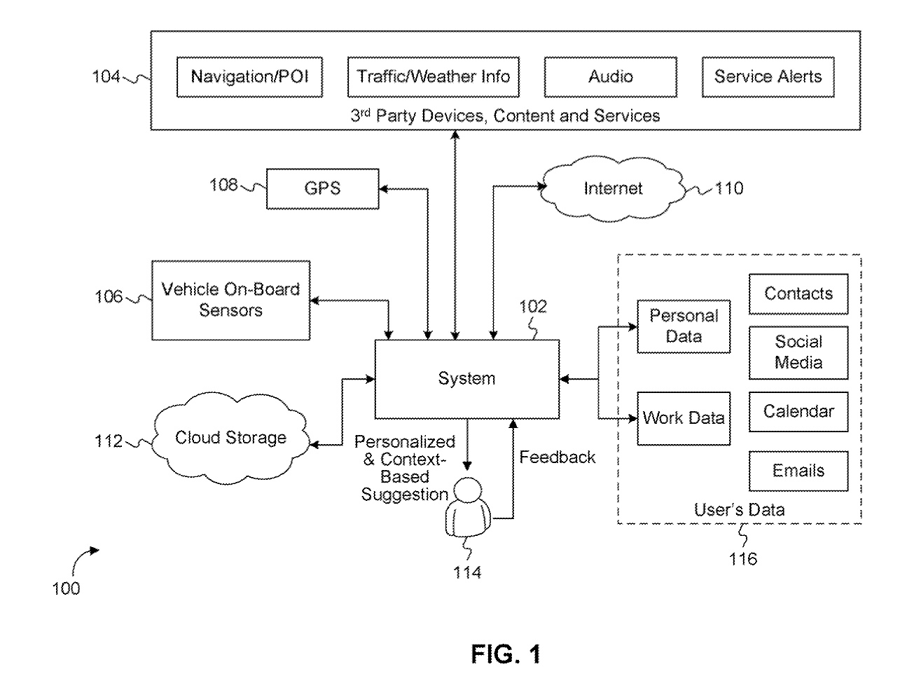

FIG. 1 broadly illustrates how a system in accordance with the present disclosure may interact with a user and various other components. The system 102 interacts with a user 114 and one or more data sources. The various data sources include third party providers 104, vehicle on-board sensors 106, a Global Positioning System 108, the Internet 110, and a cloud storage 112. The system 102 and the data sources may be in communication which each other via various device communication protocols. These protocols may include, inter alia, radio wave transmission, Universal Serial Bus (USB), Bluetooth, hardware plug-ins, WiFi and other wireless local area network (WLAN) protocols, and 3G/4G/LTE and other wide area network (WAN) protocols. The connection between particular data sources and/or the system 102 may employ the same or different protocols. For example, the vehicle on-board sensors 106 may be in communication with the system 102 via a Bluetooth wireless protocol, while the third party providers 104 may be in communication with the system 102 via radio transmission.

The system 102 may act as a digital “companion” to the user 114, functioning to ease many of the inconveniences that the user 114 may face while driving. These inconveniences may arise from the user's inability to easily manipulate digital devices while driving in order to obtain critical information. In order to address this problem, system 102 first establishes a profile of the user 114. The user profile generally comprises information reflecting the user's past activities, preferences, and other information associated with the user. The user profile may include the user's data, shown as block 116. including personal data, work data, preferences or choices, and so on. Such data may include routes frequently driven by the user, the user's previous destinations or navigation routes, the user's contacts, the user's email accounts, the user's calendar, the user's social media information, and the user's schedule. Various activities may be included, such as visiting a particular address or locations, shopping places, restaurants and the like. The profile information can be obtained from an existing device owned by the user, such a mobile phone, tablet computer, or other computing device. These devices may be placed into communication with the system 102 using one or more various communication protocols, as discussed. Alternatively, the user 114 can manually provide profile information by inputting responses to predefined questions presented by the system 102. The profile information can be obtained from the Internet 110, third party providers 104, or other available sources. The user profile may comprise information regarding at least one of the user's demographic background, previous destinations or navigation routes of the user, the user's contacts, the users preferences and/or tastes, and activities conducted by the user. The activities conducted by the user may include, for example, visiting a particular address or other location, shopping, eating food at a restaurant, listening to music, and watching videos.

Further, the system 102 captures contextual information related to and/or relevant to the user 114. Here, contextual information generally comprises real-time information about the user 114, the vehicle, the route, or other relevant factors. The contextual information can be obtained from on-board vehicle sensors 106 third party providers 104, email accounts, calendars, user contacts, or social networks. More particularly, the system 102 may identify user context based on the profile information and the contextual information. For example, if particular data is personal in nature, the system 102 could find out whether any of the user's friends is located on or near the user route. But, if data is related to work, the system 102 could determine whether the user 114 had received a work e-mail since last checking. Contextual information related to and/or relevant to the user may comprise a route provided by the user, a present date and time, a measurement of traffic conditions being experienced by the user, the proximity of contacts known to the user, the make, model, and/or other identifying characteristics of a vehicle occupied or owned by the user, geographic points of interest, and weather conditions.

Based on the profile information and/or contextual information, system 102 provides one or more suggestions to the user 114. For instance, the system 102 may obtain contextual information indicating that a contact of the user 114 is only a few minutes in driving time from the user's route. Further, based on social communications and social media information stored in the user profile, the system 102 may also determine that the contact is a friend of the user 114. Based on that determination, the system 102 may inform the user 114, “Your friend Peter is at a few minutes away from your route; would you like meet?” In an embodiment, the suggestions may be provided to the user 114 through a voice based interface. In other implementations. the suggestions can be displayed to the user 114 through a display device or other Human-Machine Interface (HMI) that avoids distractions to the driver while driving.

Once the suggestions are presented, the user 114 provides feedback. Based on that feedback, the user profile may be modified or updated. The next time suggestions are offered, the system 102 refers to the updated profile. Thus, the system 102 may periodically or constantly track, stores, and learn from decisions and choices made by the user 114. These actions may improve the user profile allowing the system 102 to provide more accurate and relevant suggestions. Thus, the updated profile represents a refined and more accurate representation of the user 114.

The system 102 may provide suggestions both when such suggestions are requested and upon the systems own initiative. For example, if the user 114 is hungry and initiates a request to find a nearby restaurant, the system 102 searches its resources, determines information such as nearby geographic points of interest stared as contextual information, and provides a suggestion. in another example, the system 102 may determine that the user's favorite restaurant lies on the current route and that the present time is close to a customary mealtime. The system 102 may consequently provide a suggestion to the user 114 without seeking any user input. Along with the suggestions, the system 102 can be configured to calculate routes, provide route guidance to the user 114, advise the user about speed limits, and provide other navigational aid.

Communication with third party providers 104 allows the system 102 to gather information including location data, Point of Interest (POI), and en-route information. The last category can include traffic, weather, vehicle service alerts and so on. In some embodiments, the location data can be obtained from the GPS 108, which communicates with a GPS satellite network to provide highly accurate, real-time vehicle location data. Based on that information, the system 102 calculates routes, and that information can be combined with other information sources to provide a complete picture of the upcoming route.

Vehicle on-board sensors 106 can include sensors capable of providing information regarding conditions affecting vehicle or travel, including traffic sensors, temperature sensors, or weather sensors. These sensors obtain the required information related to traffic, temperature, and weather, respectively. Other sensors may include a vehicle velocity sensor a vehicle position sensor, a mileage sensor, a fuel sensor, an oil level sensor, a wiper fluid level sensor, an environmental sensor, and sensors that provide information regarding the status of an associated vehicle.

Cloud storage 112 may store information used by the system to provide personalized and context-aware suggestions. Such information may include the user profile and/or contextual information. The information stored over the cloud storage 112 can be accessed from anywhere, at any time. Alternatively, the cloud storage 112 may be supplemented and/or replaced with a local storage medium, e.g. various incarnations of non-volatile memory hard drives. In certain embodiments, the system includes both a local storage and cloud storage 112.

As discussed above, the system 102 may be an in-vehicle system integrated with an on-board navigation system (not shown). In other embodiments, the system 102 can be integrated with other devices, such as mobile phones, smartphones, tablets, or similar devices. In other embodiments, the system 102 may be an application that can be installed on any such device as discussed. The system 102 can be a stand-alone system or device, or it can be a combination of existing hardware and software modules.

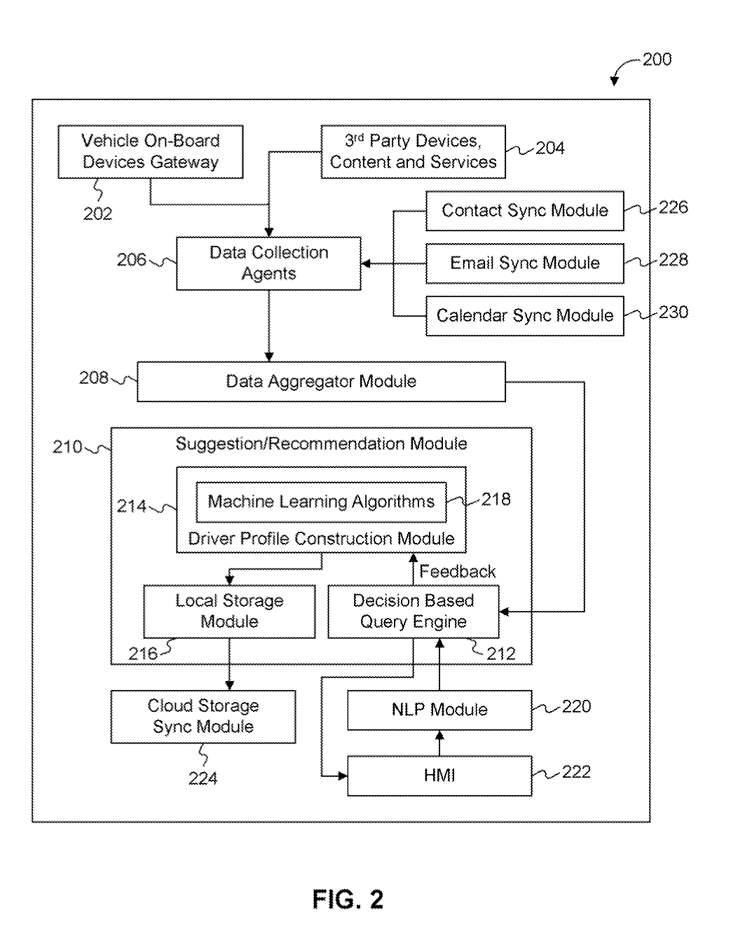

FIG. 2 illustrates various components 200 of the system 102. In particular, such a system can include a vehicle onboard devices gateway 202, a third party provider module 204, data collection agents 206, a data aggregator module 208, a suggestion/recommendation module 210, a cloud storage sync module 224, a Natural Language Processing (NLP) module 220, and a Human Machine Interface (HMI) 222.

The vehicle on-board devices gateway 202 or, more simply, gateway, may include one or more gateways that allow integration with different systems or platforms through appropriate interfaces and/or protocols. Such interfaces include, but are not limited to, Universal Serial Bus (USB), Bluetooth, hardware plug-ins, WiFi and other wireless local area network (WLAN) protocols, and 3G/4G/LTE and other wide area network (WAN) protocols. Here, the gateway 202 may include a service gateway for integrating with third party content and service providers 204 to obtain profile information, navigation information, audio/video, service alerts, and so on. The gateway 202 may further include gateways for syncing with users' email accounts, contacts, calendars, and social media information. Syncing helps in identifying a relevant upcoming event, such as a scheduled meeting or a reminder, as well as emails or posts on social media. Additionally, the gateway 202 may integrate with on-board sensors 106 to acquire the required information as discussed above.

Data collection agents 206 collect data through gateway 202, as discussed above. The collected data can be of any form and type, such as navigational data, POI data, multimedia data (audio and/or video), traffic, weather information, infotainment data and other service alerts. The data can be collected from various third party content and service providers 104, or it may be sourced through GPS 108 or the Internet 110. Additionally, data collection agents 206 collect user data from user devices, such as mobile phones, tablets, personal digital assistants, etc., for example. To perform this function, data collection agents 206 sync with modules such as email sync module 228, contact sync module 226, and calendar sync module 230. Through email sync module 228, the data collection agents 206 check whether or not the user 114 has received any email. Through contact sync module 226, agents 206 obtain user contact information—for example, whether a user contact is in an area near the user's route and so on. The calendar sync module 230 helps in obtaining any upcoming reminders or meetings. Herein, data collection agents 206 collect data from various sources, discussed above, after a pre-defined time interval, such as 5 minutes. Additionally, data collection agents 206 collect various attributes that could be linked to user activities. These attributes could include time, day, frequency, demography, route, personal relation, and the like. The data aggregator module 208 aggregates data collected by data collection agents 206. It may also send the aggregated data to the suggestion/recommendation module 210, in particular to the decision based query engine 212.

The suggestion/recommendation module 210 may include a driver profile construction module 214, a local storage module 216, and a decision based query engine 212. The driver profile construction module 214 parses the information provided by the data aggregator module 208 to determine and/or update elements of the user profile. The elements correspond to the information content of the user profile. For example, an element of the user profile may represent the users preference for Italian food. The decision based query engine 212 accesses information stored in the user profile and parses the information provided by the data aggregator module 208 in order to determine contextual information relevant to and/or related to the user. The decision based query engine 212 then compares information in the user profile to the contextual information to determine whether to offer any suggestions. This process employs the user profile (past data) to relate to an activity of the user 114 or route information, in real time (present data) to build a context and, accordingly, provide appropriate suggestions to the user 114 while the user 114 is driving or otherwise indisposed.

For example, the decision based query engine 212 may understand that the user profile includes a reminder for daily operations meeting at 4:00 PM. The engine 212 also knows that the current route is experiencing traffic congestion. The engine 212 then determines that the likely delays will make the user late for his 4:00 PM meeting. Based on that determination, the decision based query engine 212 may offer a suggestion to the user 114 via the HMI 222, which may be a voice-based interface (i.e. an interface capable of receiving input and providing output in verbal or audio form), a touch-sensitive interface (e.g. a capacitive, resistive, or otherwise touch-sensitive surface), a visual display device, and/or combinations of the foregoing (e.g. a visual display device that comprises a touch-sensitive surface). The suggestion could say, “Considering that the current route is jammed because of traffic conditions, and you will be late for the daily meeting by at least 10 minutes, would you like to email all the attendees?”

Once the suggestion is provided to the user 114, the user 114 provides feedback to the offered suggestions. In addition to responding according to the user feedback, the system may provide the feedback to the driver profile construction module 214. The module 214 employs tools such as machine learning algorithms and the like, shown as block 218, to modify the user profile. Various machine learning algorithms and/or methodologies can be employed for this task, including expert systems, semantics, fuzzy logic, neural networks, and genetic learning.

In certain embodiments, the machine learning algorithm 218 may generally operate by assigning and/or adjusting the priority of elements of the user profile, reflecting the importance of the element to the user. In certain embodiments, the priority may be expressed in a numeric fashion, e.g. priority ranking values. Based in part on these priority ranking values, the decision based query engine 212 determines when to provide a suggestion and which suggestion to provide. For example, the decision based query engine 212 may consider a vector of user profile elements. These elements, as previously described, may include the location of one of the user's contacts, as well as the location of the users favorite restaurant. Each of these elements may be associated with one or more priority ranking values as assigned by the machine learning algorithm 218. The decision based query engine 212 may further consider contextual information, particularly the location of the user provided by the GPS 108 and the present date and time. Based on the foregoing data, the decision based query engine decides whether to provide a suggestion and which suggestion to provide. For example, though the distance between the user and the contact (as computed from their GPS locations) may be much smaller than the distance between the user and the favorite restaurant, the decision based query engine 212 may determine that no suggestion should be provided because the priority ranking value associated with the contact is below a given threshold value. As the user's location changes and the time gets closer to a customary meal time, the decision based query engine 212 may determine that the priority value associated with the user's favorite restaurant is sufficient to surpass the given threshold value. Accordingly, a suggestion may then be provided to the user: “Would you like to go to XYZ restaurant for lunch?”

In the same foregoing exemplary scenario, the machine learning algorithm 218 may then categorize the feedback received from the user in response to the suggestion as positive feedback or negative feedback. For example, if the user responds by saying “Yes, take me to XYZ restaurant,” such feedback would be categorized by the machine learning algorithm as positive feedback. If the user does not respond at all or responds by saying “No,” then the machine learning algorithm 218 may categorize the feedback as negative feedback. Various degrees of categorization may be accorded to the user feedback, e.g. from somewhat positive or negative to extremely positive or negative. Based on the categorization, the machine learning algorithm 218 may then adjust the priority ranking values of elements of the user profile. Generally, the manner of the adjustment depends on the particular type of machine learning algorithm 218 employed. For example, in a genetic-type machine learning algorithm, the algorithm may combine previously stored vectors of user profile elements (with their associated priority ranking values) while also randomly “mutating” a small number of priority ranking values to obtain a new vector of user profile elements having associated priority ranking values equal to the mean of the priority ranking values associated with the previously stored vectors. The previously stored vectors are the selected by the algorithm based on their “fitness,” or whether they were successful in eliciting positive feedback from the user. With successive iterations of the algorithm, the vector of user profile elements and associated priority ranking values may better reflect the users desires, preferences, and tastes, thereby improving the quality of personalized and context-aware suggestions. In this manner, the ability of the system 102 to provide personalized and context-aware suggestions to the user may improve based on user feedback. The foregoing description of a genetic-type machine learning algorithm is merely exemplary of many possible machine learning algorithms

User feedback can be provided through NLP module 220. The NLP module 220 converts the user speech into text to obtain the relevant information. Information is sent to the query engine 212 for further processing. For example, if the user 114 provides his input through the voice based interface, asking, “What is my present location?” HMI 222 may receive that query and send the users speech to NLP module 220 for further processing. The NLP module 220 receives the user voice and then converts it into text and then sends it to decision based query engine 212. The decision based query engine 212 communicates with data collection agents 206 to know the users current location and, subsequently, the user's location is provided through the HMI 222.

Local storage module 216 stores the user profile as initially established by the system 102. Along with this, the local storage module 216 receives an updated user profile from the driver profile construction module 214. The local storage module 216 also stores vehicle profile information and other information such as maps, POIs, navigation information, and so on. The local storage module 216 syncs with cloud storage sync module 224 to store data on cloud storage 112 discussed above. The cloud storage sync module 224 synchronizes with the data stored in the local storage module 216 with the external cloud storage.

Upon initialization, the system 102 integrates with all the data sources using various service gateways. For instance, once the user 114 connects his/her personal mobile device to the system 102, the system 102 syncs up with the available data such as Outlook calendars, email accounts, social media information using the calendar, contacts, email sync gateways. Similarly, once the system 102 is connected to GPS 108, it retrieves all location related information of the vehicle and POIs using the 3rd party devices, content gateways, and services gateways. Further, when the system 102 is connected to the Internet 110, it is able to retrieve data related to the user across various platforms, both on local devices and on the Internet.

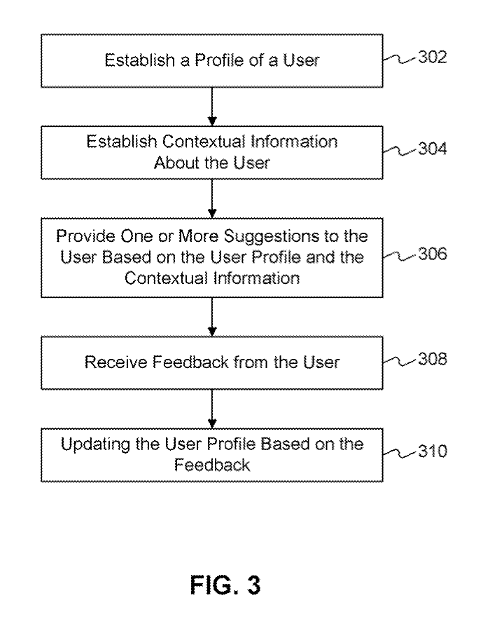

FIG. 3 is a flowchart for providing personalized and context-based suggestions to a user 114, initially, the method sets up a user profile. To establish the profile, the system 102 may request information about the user 114, including preferences—favorite restaurants, shops, entertainments, or frequent driving routes. The information may also include the users contacts, user schedules, demographic information, family, relatives, and the user's likes or dislikes. Such information can be provided by the user 114 through a voice-based interface or other human machine interfaces, as discussed above. Some embodiments can allow preferences to be pre-configured as a pre-defined template, based on the general category of the user/driver. Such preferences can be obtained from market or research analysis. Once the profile of the user 114 is established, the system 102 is ready for use. As part of this initialization, the machine learning algorithm may prioritize elements of the user profile, e.g. by assigning numerical priority ranking values.

Along with the user profile, the system 102 establishes a car profile, including car type, type of fuel used, engine capacity, and other details. The car profile may be provided by the user 114, or it can be obtained from on-board devices or Internet 110. The user profile and car profile may be stored in the local storage module 216.

Operation in a given instance often begins by receiving an input from the user 114. The input can include a current location and destination. Based on the received input, the system 102 calculates one or more routes and displays them to the user 114. Then, the user 114 selects one of the routed via which he wishes to travel. Based on the selected route, route instructions or directions are displayed to the user 114 through the display device.

In one context of the present disclosure, the method includes providing a profile of the user 114, at 302. The user profile records user activity, including contacts, locations, and the like. After this, at 304, current or contextual information relevant to the user 114 is established, which may include information regarding a route on which the user 114 is driving. The contextual information is the real time information about the user 114, the route, the vehicle, or other relevant information. The contextual information can include environmental data, personal or work related data, or activity of the user 114. For example, the contextual information can be various POIs, entertainment, traffic information, weather information, and the like. Such contextual information can be obtained from on-board vehicle sensors 106 or devices, third party providers 204, and other sources of information.

In further examples, the contextual information may be email or entries on social media. For example, a Facebook entry might indicate that one of the user's friends is expected to visit a Mega Mall on ABC road at 4:00 PM. Such contextual information is obtained by syncing with user's email accounts, social networks, and calendars.

After establishing the contextual information, the system 102 may determine whether there is any upcoming event for the user 114 on his route. Based on the combination of the user profile information and the current information, one or more suggestions may be provided to the user 114, at 306. The suggestion may include, “You have a meeting at 4:00, and because of traffic difficulties you may be late for the meeting by at least 15 minutes. Would you like to reschedule the meeting, or would you like to take an alternative route?”

In another example, the system 102 may note that a restaurant on the users route is offering a special price for pizza: buy one get one free. Combining that information with fact that the user's profile indicates a liking for pizza, results in a system suggestion: “There is a restaurant offering special pricing on pizza. Would you like to visit it?”

If the user 114 responds positively to that situation, the system 102 may calculate further actions required. Here, those actions might include an automatic route selection or reservation of a table, room, or ticket. Other actions might include automatically calling a contact, automatically re-scheduling a meeting, or so forth.

Thereafter, at 308, user feedback is received through a voice based interface. Then, the user speech is processed using natural language processing algorithms and is converted into text. As a next step, the user profile is modified based on the feedback, at 310. In this way, the user profile is modified to provide better suggestions and more relevant information to the user 114. Here, modifying the user profile may also include modifying a pre-defined template having information about the user 114.

Additionally, the method includes storing data in terms of timelines. For example, the system 102 can store events occurring between 8:30 AM to 9:00 AM, and, if a user alert is indicated, then appropriate notification can be provided.

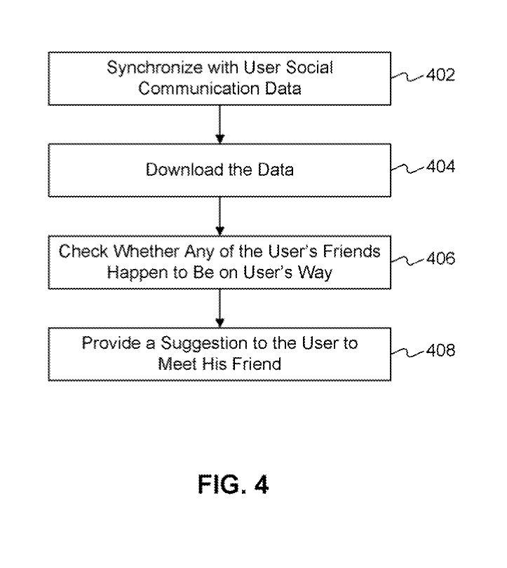

FIG. 4 shows various exemplary method steps for one usage scenario of the disclosure. In the illustrated embodiment, the method includes syncing with user personal data in the form of social communication data, at 402. The user's personal data can be obtained from user's device or from other data sources. After syncing, the method includes downloading the social communication data, at 404. Thereafter, the method includes tracking and checking whether any of the users friends happen to be in the area that falls on the route of the user 114, at 406. This information can be obtained from the Internet 110, social networking websites, or other data sources. Based on the results of that inquiry, a suggestion is provided to the user 114 to meet his friend, at 408. The suggestion can be, “Would you like to meet your friend Daniel, who is in a nearby area.” Subsequently. the user 114 can choose to meet his friend.

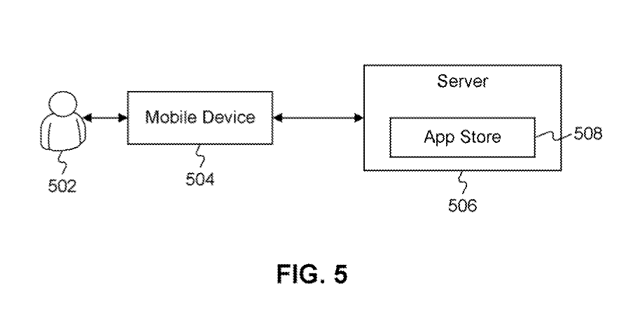

FIG. 5 illustrates an exemplary scenario wherein an embodiment of the present disclosure may be obtained from an application store (app store) 508. A non-transitory computer readable medium in this scenario may store instructions that when executed by one or more hardware processors provides the systems and methods in accordance with embodiments of the present disclosure as described above. The non-transitory computer readable medium may exist in a server 506 that connects to a device, which in certain embodiments is a mobile device 504, e.g. a smartphone, a computer tablet, a GPS, a personal digital assistant, a wearable computing device, etc. The mobile device 504 may be owned or otherwise associated with a user 502. The connection between the mobile device and the server may occur through the Internet or other communication protocols, e.g. Universal Serial Bus (USB), Bluetooth, hardware plug-ins, WiFi and other wireless local area network (WLAN) protocols, and 3G/4G/LTE and other wide area network (WAN) protocols. The app store 508 provides an interface through which the user 502 may obtain a copy of the instructions stored on the non-transitory computer readable medium existing on the server 506 that when executed by one or more hardware processors provides the systems and/or methods in accordance with the present disclosure described above. The user 502 may interact with the app store 506 using an interface executed on the mobile device 504. In the present scenario, the user 502 may request a copy of the instructions stored in the app store 508 using mobile device 504; the instructions may then be transmitted by the app store 508 from server 506 to the mobile device 504. In this manner, the mobile device 504 may itself comprise a non-transitory computer readable medium comprising instructions that when executed by one or more hardware processors provides the systems and methods in accordance with embodiments of the present disclosure described above. Upon execution of the instructions by one or more hardware processors, the mobile device may essentially become a system in accordance with the present disclosure, capable of performing the steps of a method in accordance with the present disclosure.

### Examples

For a better understanding of the disclosure, the following exemplary scenarios are described. Those of skill in the art will understand that these scenarios are illustrative in nature and do not limit the scope of the disclosure.

Knowing that the user 114 recently visited XYZ store, the system 102 provides the following suggestions to the user 114—“You are about to drive near the XYZ store that you visited last week. The store is offering a discount sale with up-to 50% off on MSRP on all products.” Alternatively, the suggestion might be, “You are about to drive past the XYZ store you visited last week. That store is having a sale”.

Along with these suggestions, the system 102 may also pose a query that requires completion of a task. For example, in continuation of the suggestion above, a follow-up query could be “Would you like me to navigate there?” If the user 114 responds affirmatively, the system 102 uses the gateway 202 to complete the task. Here, for example the system 102 can use third party devices, content, and services 204 to communicate with the GPS device 108 to plan a route.

In another scenario, the system 102 provides timely suggestion to the user 114, based on a stated preference for Indian Cuisine. The suggestion could be, “It is close to dinner time and there is a restaurant nearby offering Indian cuisine”. In cases where the request is initiated by the user 114 asking for a nearby restaurant, the suggestion may be: “There are two restaurants—Restaurant X at address ABC, and restaurant Y at address PQR.”

In another example, assume that the user's vehicle is running low on fuel or, perhaps, even if the fuel level is not yet low, the vehicle may lack sufficient fuel to reach the planned destination. The system 102 evaluates the context and becomes aware of this situation as it has access to car's on-board diagnostic (OBD) through the system's OBD interface gateways. System 102 then uses the vehicle profile information, such as the fuel type, along with other contextual information such as current location, to warn the user 114 about the fuel problem and suggesting a route to the nearest fuel station, based on the required type of gasoline or an optimal price.

In a further example, assume that the user 114 is driving at a speed at 70 mph in a 55 mph speed limit zone. Here, system 102 understands the context that the user 114 is driving over the speed limit and should slow down. Accordingly, the system 102 suggests, “You are driving 70 mph in a 55 mph speed limit zone. Please slow down”.

The present disclosure discloses a method and a system for providing personalized and context-based suggestions to a user. The system and methods disclosed here have many advantages. For example, the system enhances the productivity of the user and addresses the inconveniences caused by the user while driving. The disclosed system is capable of providing suggestions in response to user requests as well as in response to program criteria.

Embodiments of the present disclosure may be used in any vehicle. In addition, at least certain aspects of the aforementioned embodiments may be combined with other aspects of the embodiments, or removed, without departing from the scope of the disclosure.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

What is claimed is:

1. A method of providing personalized and context-aware suggestions to a user in a vehicle, the method comprising:
providing a user profile;
establishing contextual information relevant to the user, wherein the contextual information comprises information obtained from social communications of the user;
providing a suggestion to the user, while the user is in a vehicle, based on the user profile and the contextual information; and
modifying, using a machine learning algorithm executed on a processor, the user profile based on user feedback received in response to the suggestion.

2. The method of claim 1, wherein providing the user profile comprises modifying a pre-defined user template with information about the user.

3. The method of claim 1, wherein establishing the contextual information comprises obtaining the contextual information from at least one of:
on-board vehicle devices;
third-party content and services; or
email accounts, social networks, calendars, and contacts of the user.

4. The method of claim 1, wherein the user profile includes information regarding at least one of:
the user's demographic background;
previous destinations or navigation routes of the user;
the user's contacts;
the user's schedule;
the user's preferences or tastes; or
activities conducted by the user, including at least one of visiting a particular address or other location, shopping, eating food at a restaurant, listening to music, or watching videos.

5. The method of claim 1, wherein the social communications of the user include at least one of:
emailing a contact;
chatting with a contact;
messaging a contact;
calling a contact; or
posting a message on a social media platform.

6. The method of claim 1, wherein the contextual information further comprises at least one of:
a route provided by the user;
a present date and time;
a measurement of traffic conditions being experienced by the user;
the proximity of contacts known to the user;
the make, model, and/or other identifying characteristics of a vehicle occupied by the user;
geographic points of interest; or
weather conditions.

7. The method of claim 1, wherein the machine learning algorithm modifies the user profile based on user feedback received in response to the suggestion by:
categorizing the user feedback as positive feedback or negative feedback: and
adjusting priorities associated with elements of the user profile based on whether positive feedback or negative feedback was received in response to the suggestion.

8. The method of claim 1, wherein providing the suggestion to the user comprises providing the suggestion through a voice based human machine interface.

9. The method of claim 8, wherein the user feedback is received through the voice based human machine interface and processed using a natural language processing algorithm to modify the user profile.

10. A system for providing personalized and context-aware suggestions to a user, the system comprising:
one or more hardware processors; and
a memory storing instructions to configure the one or more hardware processors,
wherein the one of more hardware processors are configured by the instructions to:
provide a user profile;
establish contextual information relevant to the user, wherein the contextual information comprises information obtained from social communications of the user;
provide a suggestion to the user, while the user is in a vehicle, based on the user profile and the contextual information; and
modify the user profile based on user feedback received in response to the suggestion using a machine learning algorithm being executed on the one or more hardware processors.

11. The system of claim 10, wherein the one or more hardware processors are further configured by the instructions to provide the user profile by modifying a pre-defined user template with information about the user.

12. The system of claim 10, wherein the one or more hardware processors are further configured to establish the contextual information by obtaining the contextual information from at least one of:
on-board vehicle devices;
third-party content and services; or
user email accounts, social networks, calendars, and contacts.

13. The system of claim 10, wherein the user profile includes information regarding at least one of:
the user's demographic information, office address, residence address, family information, and/or personal relationships;
previous destinations or navigation routes provided by the user;
the user's contacts:
the user's schedule;
the user's preferences or tastes; or
activities conducted by the user, including at least one of visiting a particular address or other location, shopping, eating food at a restaurant, listening to music, and watching videos.

14. The system of claim 10, wherein the contextual information further comprises information regarding at least one of:
a route provided user;
a present date and time;
a measurement of traffic conditions being experienced by the user;
the proximity of contacts known to the user;
the make, model, and/or other identifying characteristics of a vehicle occupied by the user;
geographic points of interest; or
weather conditions.

15. The system of claim 10, wherein the social communications of the user include at least one of:
emailing a contact;
chatting with a contact;
messaging a contact;
calling a contact; or
posting a message on a social media platform.

16. The system of claim 10, wherein the machine learning algorithm modifies the user profile based on user feedback received in response to the suggestion by:
categorizing the user feedback as positive feedback or negative feedback; and
adjusting priorities associated with elements of the user profile based on whether positive feedback or negative feedback was received in response to the suggestion.

17. The system of claim 10, wherein the one or more hardware processors are further configured by the instructions to provide the suggestion through a voice based human machine interface.

18. The system of claim 17, wherein the one or more hardware processors are further configured by the instructions to receive the user feedback through the voice based human machine interface and process the user feedback using a natural language processing algorithm to modify the user profile.

19. A non-transitory computer-readable medium storing instructions for providing personalized and context-aware suggestions to a user in a vehicle, wherein execution of the instructions by one or more processors causes the one or more processors to:
provide a user profile;
establish contextual information relevant to the user, wherein the contextual information comprises information obtained from social communications of the user;
provide a suggestion to the user, while the user is in a vehicle, based on the user profile and the contextual information; and
modify the user profile based on user feedback received in response to the suggestion using a machine learning algorithm.

20. The non-transitory computer readable medium of claim 19, wherein the stored instructions further cause the one or more processors to provide the suggestion through a voice based human machine interface.
